(19) United States
(12) Patent Application Publication
(10) Pub. No.: US 2012/0243696 A1
(43) Pub. Date: Sep. 27, 2012

(54) Supervisory Method and Apparatus for Audio Input Path

(75) Inventor: Robert H. Brockelsby, Louisville, KY (US)

(73) Assignee: Honeywell International Inc., Morristown, NJ (US)

(21) Appl. No.: 13/235,249

(22) Filed: Sep. 16, 2011

Related U.S. Application Data
(60) Provisional application No. 61/412,715, filed on Nov. 11, 2010.

(51) Int. Cl. H04R 29/00

(52) U.S. Cl. 381/58

(57) ABSTRACT

A supervisory apparatus and method are useable with personal, or micro-computers. A passive module can be coupled to a computer sound card. The module can be coupled to a speaker and a microphone. The speaker can emit a supervisory audio signal generated by the sound card. The microphone can sense and feedback the supervisory signal. Where no supervisory audio has been detected during a pre-set time interval, an audio path failure can be reported.

### CROSS-REFERENCE TO RELATED APPLICATION

This application claims the benefit of the filing date of U.S. Provisional Application Ser. No. 61/412,715 filed Nov. 11, 2010, entitled Supervisory Method and Apparatus for Microphones. The '715 application is hereby incorporated herein by reference.

### FIELD

The application pertains to supervision of audio paths of emergency communications systems. More particularly the application pertains to systems and methods to supervise components of audio input paths.

### BACKGROUND

Emergency communication systems are required to monitor the integrity of all components in the audio path. Standard audio input supervision devices rely on electrical supervision of the audio path. Such devices are not capable of detecting mechanical damage to the microphone unless it also damages the electrical path. Additionally, standard audio input supervision requires the use of additional dedicated supervision circuits. Standard audio input circuits on a personal computer (PC) are not capable of this level of monitoring.

Providing a supervising function which can be implemented on a PC could be very useful considering that such computers are commonly found in communications equipment.

### BRIEF DESCRIPTION OF THE DRAWINGS

FIGS. 1A-1C are diagrams which taken together illustrate aspects of an embodiment of a supervisory system;

FIG. 2 is a schematic diagram illustrating other aspects of the embodiment of FIG. 1;

FIG. 3 is a flow diagram of a method in accordance herewith;

FIGS. 4A, 4B are graphs illustrating aspects of the method of FIG. 3;

FIG. 5 is a block diagram of another embodiment in accordance herewith; and

FIG. 6 is a flow diagram of another method in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Embodiments hereof can include a speaker that is capable of producing a supervision tone, along with a microphone that is capable of receiving the tone, and a software implemented method for generating and detecting the tone. In one embodiment, PC speakers, a PC microphone (analog or digital), and PC application software can be used.

The device routes one of the PC speaker channels through the microphone. The control software can periodically generate a tone that can be detected on the microphone input. This guarantees the integrity of all components in the audio input path from the microphone to the programmable processor of the PC.

In one aspect, all components of the audio input path in the PC can be supervised. The PC speaker channel in another aspect functions as a supervision tone generator.

The standard PC speaker and microphone channels are attached to the device. The speakers and microphone are also attached to the device. The software monitors the microphone input for an acceptable audio signal level. If the audio level is not detected within a certain time period (Supervision Tone Time) the software will generate a tone on the right speaker channel. This tone is routed through the speaker and into the microphone input. If the audio path is functioning then the software will detect the supervision tone. If not then the software will indicate an Audio path failure. An acceptable audio signal level can restart the supervision process.

In another embodiment, an unperceivable tone (frequency outside of human hearing range) can be generated in a configuration that the microphone can receive. Control software can detect and analyze the received tone. Detection of this tone guarantees that all electrical and mechanical components of the audio input path are functioning.

This embodiment uses the unperceivable tone for electrical and mechanical supervision. Further, only audio path components are required for supervision. No additional supervision circuits are required.

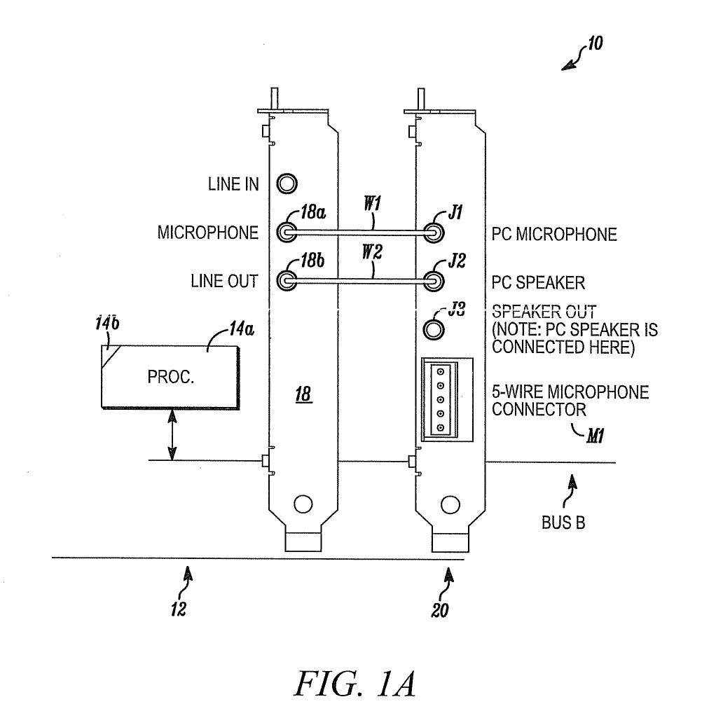

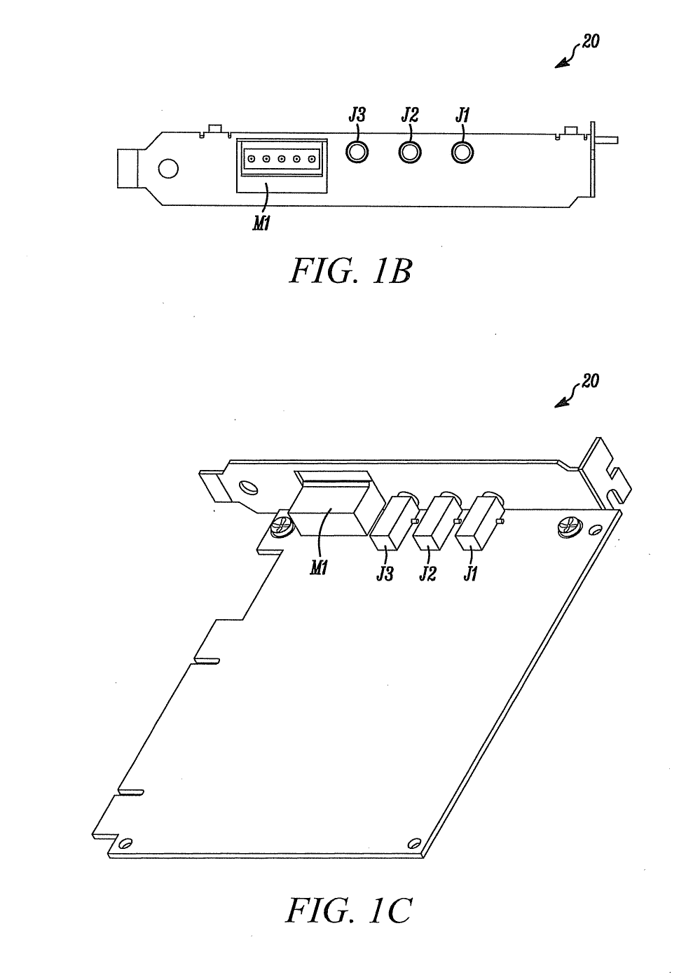

FIGS. 1A-1C illustrate aspects of an apparatus 10 which provides an audio path supervisory function, via audio path routing, in accordance herewith. Those of skill in the art will recognize that apparatus 10 is an exemplary embodiment and other variations are possible without departing from the spirit and scope of this application.

Apparatus 10 includes a programmable computer, 12, which could but need not be implemented as a PC. The computer 12 includes a programmable processor 14a which executes control software 14b which can be pre-stored on non-transitory computer readable media. Optical, magnetic and semiconductor memory units can all be used for storage of the software 14b, without limitation.

Processor 14a is coupled to a bus B for communicating with other elements of computer 12 including a sound card 18. Sound card 18 has a microphone input 18a and a speaker output 18b.

Sound card 18 is electrically coupled to a supervisory device 20. Additional structural details of device 20 are illustrated in FIGS. 1B, 1C. Unlike the sound card 18, which is coupled to bus B, the device 20 is plugged into an available slot but is not coupled to the bus B. Wires W1, W2 couple card 18 to device 20. It will be understood that the exact configurations of card 18 and device 20 are exemplary only and not limitations hereof.

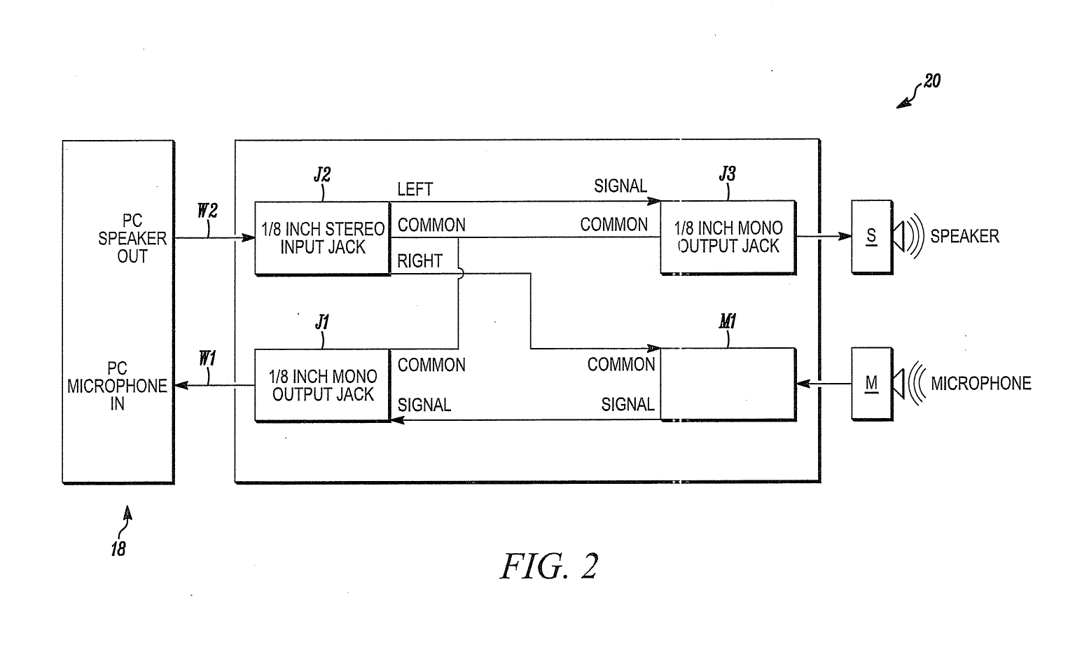

FIG. 2 illustrates additional electrical details of device 20. Device 20 is also couplable to a speaker S, which can be associated with computer 12, and a microphone M. Microphone M can be used to provide feedback of supervisory audio emitted by a speaker S to supervise the audio input path of the system 10.

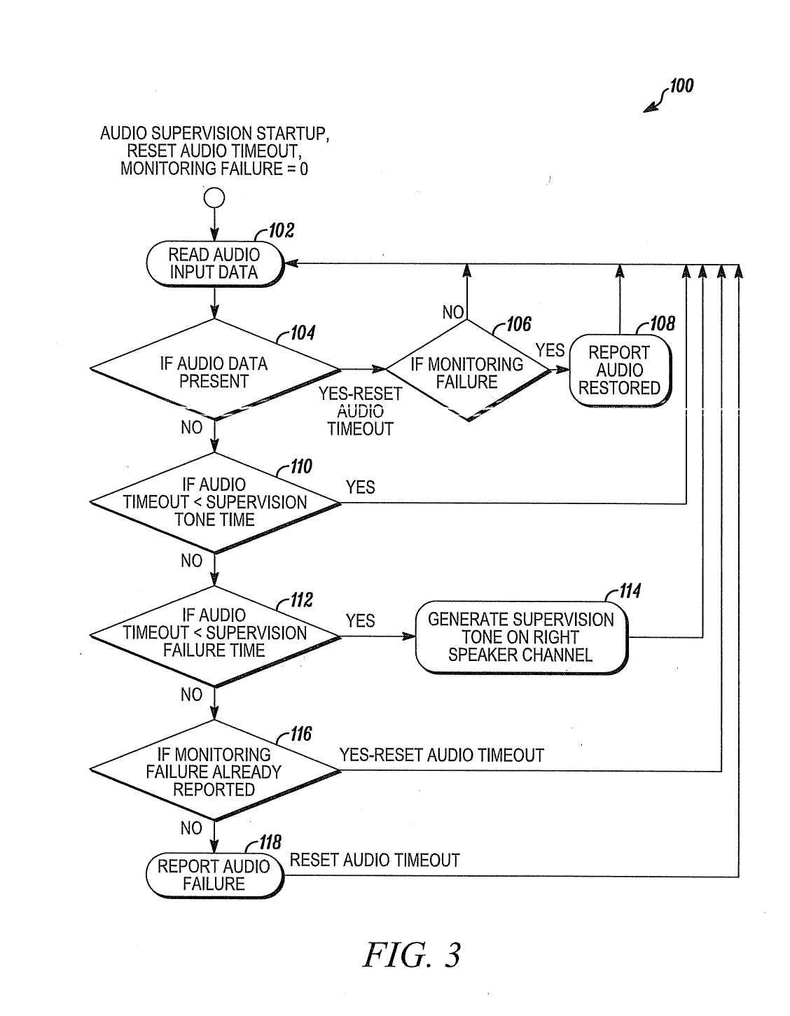

FIG. 3 illustrates a supervisory method 100 which could be implemented via the system 10. Input audio is initially read, as at 102, and a determination is made as to whether such data is present, and being detected, as at 104. In the presence of incoming audio, whatever ever the originating source, an audio timer, or timeout, is reset. In view of the sensed audio, any monitoring failure, as at 106, is reset and the presence of audio is reported, as at 108.

In the absence of audio, where the audio timeout interval exceeds a supervisory tone time interval, as at 110, and if the timeout interval is less than a failure time interval, as at 112, the device 20 can be driven by the computer 12 to emit a supervisory tone on one of the speaker channels of the card 18, as at 114.

Alternately, a determination is made, as at 116, as to whether a monitoring failure has already been reported. If not, a failure can be signaled as at 118.

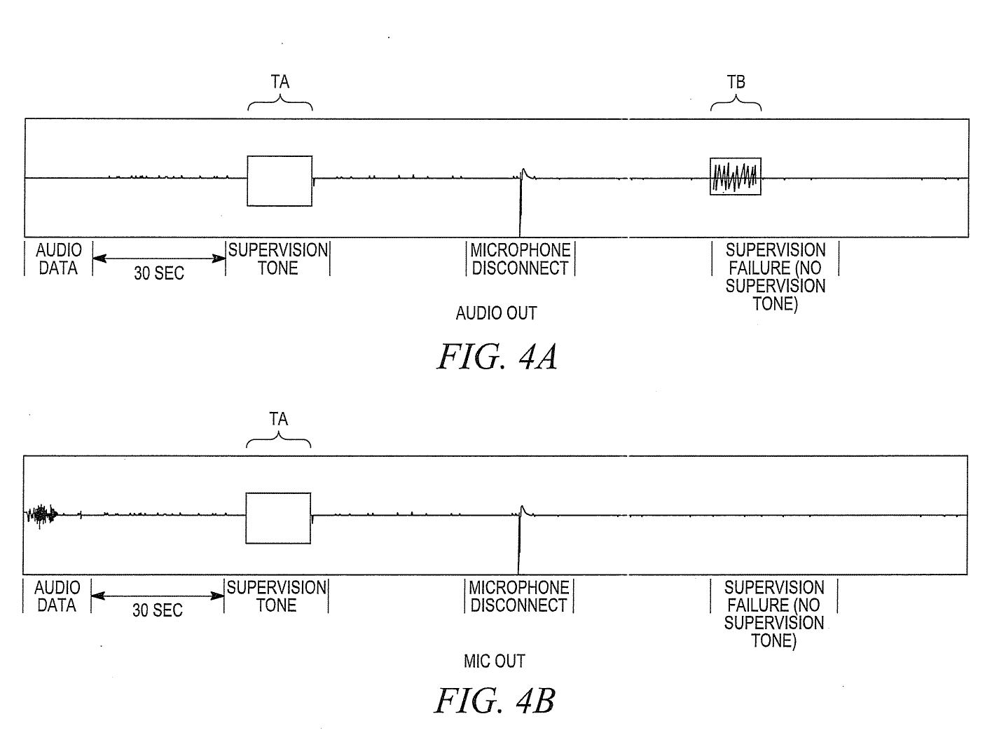

FIGS. 4A, 4B illustrate various of the signals associated with the system 10 and method 100. FIG. 4A corresponds to audio outputs from speaker S. FIG. 4B illustrates electrical signals from ambient audio detected by the microphone M. When there is local ambient audio, local speech or other noises, the audio data sensed by the microphone M, as at 102, resets the audio timer, or timeout function. After the audio timeout for example 30 seconds, as at 112, with no audio feedback, the supervision tone is generated, as at 114 and TA of FIG. 4A. Where the audio input channel is functioning properly, that audio is feedback, as at 104 indicating proper operation, and, resets the timeout indicator.

If the audio timeout interval for example 30 seconds exceeds the supervision failure time interval such as 35 seconds, as at 112 and at TB on FIG. 4B, without audio from the microphone, then a failure has occurred and can be reported, as at 112, 118.

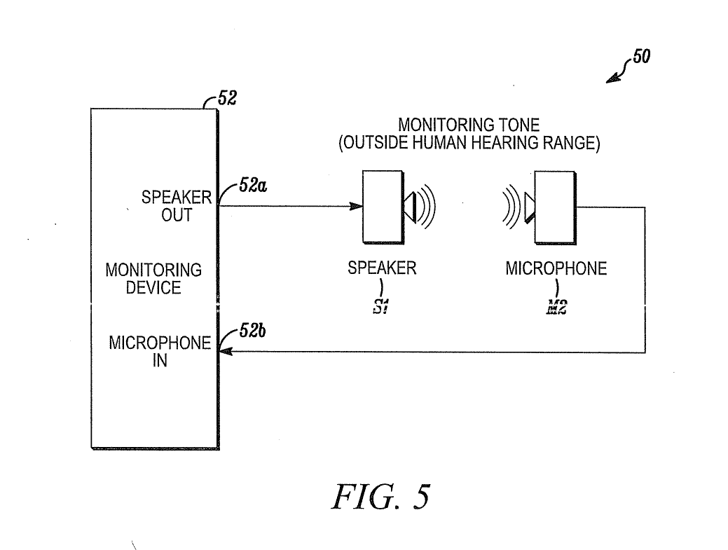

FIG. 5 illustrates an alternate apparatus 50 for supervising an audio input path. In this embodiment, unlike the prior embodiment, supervisory tones which are not human perceivable are emitted. Detection of the supervisory tone(s) provides assurances that the electrical and mechanical components of the audio input path are functioning.

Monitoring device 52 can be comparable to the computer 12 discussed previously. Signals generated at the device 52, and emitted via port 52a, drive a speaker S1. Speaker S1, in addition to emitting expected, human perceptible audio, emits the out of human range supervisory tone(s). The supervisory tone(s) are detected by microphone M2 and are fed back to port 52b for analysis by the device 52.

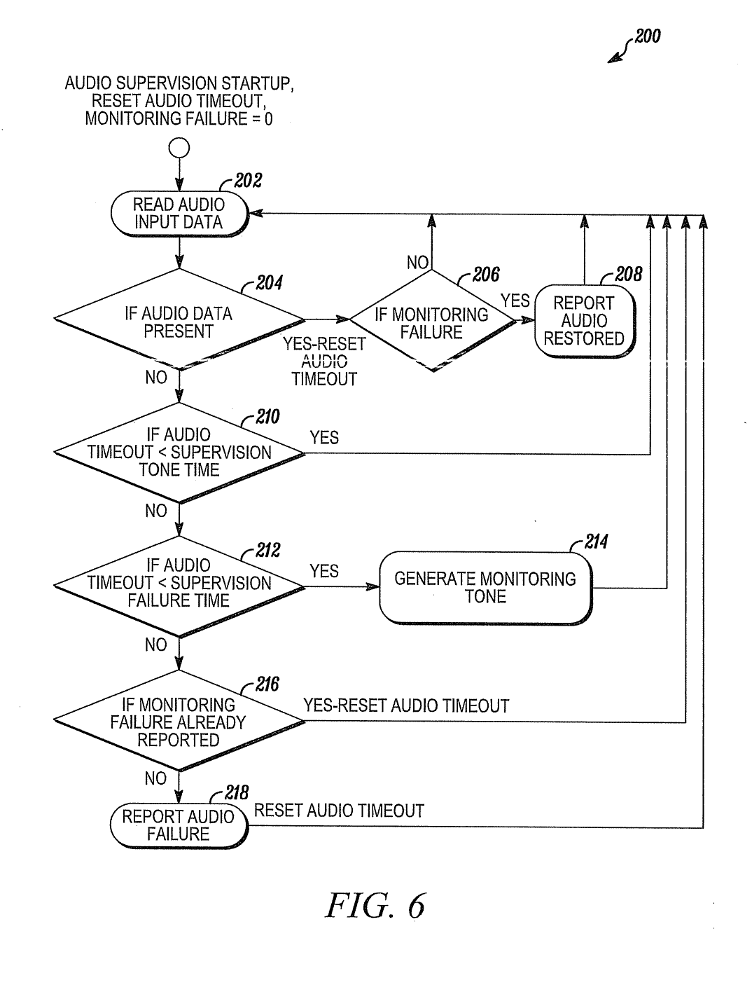

FIG. 6 illustrates a supervisory method 200 which could be implemented via the system 50. Input audio is initially read, as at 202, and a determination is made as to whether such data is present, and being detected, as at 204. In the presence of incoming audio, whatever ever the originating source, an audio timer, or timeout, is reset. In view of the sensed audio, any monitoring failure, as at 206, is reset and the presence of audio is reported, as at 208.

In the absence of audio, where the audio timeout interval exceeds a supervisory tone time interval, as at 210, and if the timeout interval is less than a failure time interval, as at 212, the speaker S1 can be driven by the monitoring device 52 to emit a human imperceptible supervisory tone(s), as at 214.

Alternately, a determination is made, as at 216, as to whether a monitoring failure has already been reported. If not, a failure can be signaled as at 218.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
control circuits coupled to an audio output transducer and a microphone, where the circuits detect the presence of signals from the microphone as indicative of expected operation thereof, and in the absence of such signals, the circuits activate the transducer to produce a supervisory signal wherein the control circuits respond to feedback signals from the microphone as indicative of expected operation thereof.

2. An apparatus as in claim 1 where the control circuits respond to an absence of feedback from the microphone as indicative of a failure.

3. An apparatus as in claim 1 where the control circuits comprise a programmable processor and executable control software where when the processor executes the control software the supervisory signal is generated and forwarded to the output transducer.

4. An apparatus as in claim 3 which includes a passive interconnect module with a supervisory signal output port and a feedback signal input port.

5. An apparatus as in claim 4 where the control circuits include a programmable computer and associated control software executed by the processor to generate the supervisory signal.

6. An apparatus as in claim 5 where the control circuits include a structure to which the module is releasibly coupled.

7. An apparatus as in claim 6 where the module includes connectors for coupling to audio input and output ports of the control circuits, and a supervisory microphone.

8. An apparatus as in claim 5 where an audio supervisory signal is generated on one output channel and non-supervisory audio is generated on another output channel.

9. An apparatus as in claim 5 where the supervisory signal comprises a human audible signal.

10. A supervisory module comprising:
a support element;
first and second control circuit input/output ports carried by the element and externally accessible;
third and fourth transducer input/output ports carried by the element and externally accessible; and
where one conductor of a control circuit input port receives monitoring signals and one conductor of a control circuit output port supplies feedback monitoring audio signals;
where one conductor of a transducer output port supplies monitoring signals and one conductor of a transducer input port receives feedback monitoring signals.

11. A module as in claim 10 where the one control circuit input port is electrically couplable to a multi-channel transducer output port and the control circuit output port is electrically couplable to a microphone input port.

12. A module as in claim 11 which is connectable to a sound card of a computer.

13. A module as in claim 12 where the sound card and the module have a similar shape and aspect ratio.

14. A module as in claim 10 where the ports carry connectors with one channel of the input control circuit port coupled to a signal line of the transducer output port.

15. A supervisory method comprising:
sensing an audio input, and responsive to the presence thereof, resetting an audio time out interval, and in the absence of the audio input, determining if a first time interval has been exceeded, and responsive to that determination, where exceeded, generating a supervisory signal on a selected output path; and
sensing the presence of an ambient input corresponding to the supervisory signal, and, in the presence thereof resetting the audio time out interval while in the absence of that ambient input reporting an audio path failure.

16. A method as in claim 15 which includes providing first and second audio output channels and generating an audio supervisory tone on one of the channels.

17. A method as in claim 16 which includes generating an output audio communication on the other channel.

18. A method as in claim 15 where the supervisory signal comprises a human perceptible audio signal.

19. A method as in claim 15 where the supervisory signal comprises a human imperceptible signal generated on a channel which also carries human perceptible audio information.

20. A method as in claim 15 which includes providing a connector module with speaker and microphone connectors.
